(19) United States
(12) Patent Application Publication
(10) Pub. No.: US 2023/0373802 A1
(43) Pub. Date: Nov. 23, 2023

(54) METHOD FOR PREPARING LITHIUM HYDROXIDE USING LITHIUM SULFATE AND BARIUM HYDROXIDE

(71) Applicant: INDUSTRY FOUNDATION OF CHONNAM NATIONAL UNIVERSITY, Gwangju (KR)

(72) Inventor: Myong Jun KIM, Gwangju (KR)

(21) Appl. No.: 18/031,052

(22) PCT Filed: Nov. 23, 2020
(86) PCT No.: PCT/KR2020/016624

§ 371 Date: Apr. 10, 2023

(30) Foreign Application Priority Data
Oct. 12, 2020 (KR) 10-2020-0131038

(51) Int. Cl. C01D 15/02

(52) U.S. Cl. CPC C01D 15/02; C01P 2006/80; C01P 2002/72

(57) ABSTRACT

In a method for preparing lithium hydroxide, a first mixture of lithium sulfate (Li₂SO₄) and barium hydroxide (Ba(OH)₂) is prepared, a second mixture that is converted into insoluble lithium sulfate (BaSO₄) and soluble lithium hydroxide (LiOH) is prepared by roasting the first mixture, the second mixture is dissolved to precipitate the insoluble barium sulfate (BaSO₄), the precipitated barium sulfate (BaSO₄) is separated by solid-liquid separation, and the solution from which the barium sulfate (BaSO₄) is separated is evaporated to obtain lithium hydroxide (LiOH).

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2020/016624, filed Nov. 23, 2020, which claims priority to the benefit of Korean Patent Application No. 10-2020-0131038 filed in the Korean Intellectual Property Office on Oct. 12, 2020, the entire contents of which are incorporated herein by reference.

### BACKGROUND

### 1. Technical Field

The present disclosure relates to a method for preparing lithium hydroxide using lithium sulfate and barium hydroxide. More particularly, the present disclosure relates to a method for preparing lithium hydroxide using lithium sulfate and barium hydroxide, which not only enables direct preparation of lithium hydroxide with high purity and low lithium loss rate but also has a simple process compared to the related art, and is economical, energy efficient, and environmentally friendly due to no waste generation.

### 2. Background Art

The expanding market for large-capacity lithium-ion batteries for electric vehicles is driving demand for lithium compounds for batteries.

Until now, the main raw material for manufacturing battery cathode materials has been lithium carbonate, but as the energy capacity of cathode materials is required to increase, NCM and NCA series cathode materials based on lithium hydroxide instead of lithium carbonate have become mainstream.

As a result, the demand for battery-grade, high-purity lithium hydroxide is growing significantly.

Lithium is traditionally extracted from salt lakes and ores.

When extracting lithium from salt lakes, the water-soluble lithium chloride is converted to the less water-soluble lithium carbonate (water solubility: 1.29 g/100 ml, 20E′), which precipitates as a precipitate, and then lithium carbonate is converted to lithium hydroxide.

When extracting lithium from ore, the ore is dissolved in water to produce a lithium sulfate solution, which is then passed through lithium carbonate, which is less water soluble, to produce lithium hydroxide, similar to the process for extracting lithium from a salt lake.

The problem with traditional lithium hydroxide preparation methods is that it is difficult to recover lithium below the solubility of the intermediate product, lithium carbonate.

The process of converting lithium carbonate to lithium hydroxide includes dissolving lithium carbonate in water and reacting the dissolved lithium carbonate with calcium hydroxide to remove the calcium carbonate that occurs as a precipitate, and then concentrating the remaining lithium hydroxide in solution to obtain high-purity lithium hydroxide.

This process can be represented by Reaction Formula 1 below.

Li₂CO₃+Ca(OH)₂→2LiOH+Ca(CO)₃(S)↓ [Reaction Formula 1]

However, the reaction in Reaction Formula 1 above is a water-based reaction, but the aqueous solubility of the reactants, lithium carbonate and calcium hydroxide, is very low, 1.29 g/100 ml (25 E′) and 0.173 g/100 mL (20 E′), respectively, which limits the amount of reactants that can be reacted at a time, and since a relatively large amount of water is used, the amount of water that needs to be evaporated to separate the lithium hydroxide later increases, resulting in high energy consumption.

In addition, since calcium carbonate is soluble in water to some extent, the lithium hydroxide solution contains calcium carbonate to some extent, and the calcium ions derived from calcium carbonate can greatly reduce the performance of lithium-ion batteries, so the lithium hydroxide obtained by removing water must be recrystallized two to three times to obtain high-purity battery-grade lithium hydroxide.

### SUMMARY

The present disclosure was created to solve the above problems, and the objective of the present disclosure is to provide a method for preparing lithium hydroxide using lithium sulfate and barium hydroxide, which not only enables direct preparation of lithium hydroxide with high purity and low lithium loss rate, but also has a simple process compared to the related art, and is economical, energy efficient, and environmentally friendly due to no waste generation.

However, the objectives of the present disclosure are not limited to the above-mentioned objectives, and other objectives not mentioned will be apparent to one of ordinary skill in the art from the following description.

A method for producing lithium hydroxide using lithium sulfate and barium hydroxide according to an embodiment of the present disclosure may include: preparing a first mixture by mixing lithium sulfate (Li₂SO₄) and barium hydroxide (Ba(OH)₂) in a certain ratio to achieve the above-mentioned purpose; preparing a second mixture that is converted into insoluble barium sulfate (BaSO₄) and water-soluble lithium hydroxide (LiOH) by roasting the first mixture; dissolving the second mixture to precipitate the insoluble barium sulfate (BaSO₄); separating the precipitated barium sulfate (BaSO₄) by solid-liquid separation; and evaporating the solution from which the barium sulfate (BaSO₄) is separated to obtain lithium hydroxide (LiOH).

Preferably, the first mixture may include lithium sulfate (Li₂SO₄) and barium hydroxide (Ba(OH)₂) in a molar ratio of 1:1.

Preferably, roasting the first mixture to prepare the second mixture converted into insoluble barium sulfate (BaSO₄) and water-soluble lithium hydroxide (LiOH) may be performed in an electric furnace at 200° C. to 280° C. for 2 to 4 hours.

The method for preparing lithium hydroxide using lithium sulfate and barium hydroxide, according to an embodiment of the present disclosure, not only enables direct preparation of lithium hydroxide with high purity and low lithium loss rate using lithium sulfate and barium hydroxide but also has a simple process compared to the related art, which is economical, energy efficient, and environmentally friendly due to no waste generation.

### BRIEF DESCRIPTION OF THE DRAWINGS

FIG. 1 is an overall process diagram of a method for preparing lithium hydroxide using lithium sulfate and barium hydroxide according to an embodiment of the present disclosure;

FIG. 2 is a graph showing the conversion of the first mixture to barium sulfate (BaSO₄) and lithium hydroxide (LiOH) when roasted according to an embodiment of the present disclosure;

FIG. 3 is an XRD result confirming that lithium hydroxide (LiOH) is produced by the method according to an embodiment of the present disclosure; and

FIG. 4 is an XRD result confirming that the solid-liquid separated precipitate is barium sulfate (BaSO₄), according to an embodiment of the present disclosure.

### DETAILED DESCRIPTION

The best mode of practicing the disclosure includes: preparing a first mixture by mixing lithium sulfate (Li₂SO₄) and barium hydroxide (Ba(OH)₂) in a certain ratio; preparing a second mixture that is converted into insoluble barium sulfate (BaSO₄) and water-soluble lithium hydroxide (LiOH) by roasting the first mixture; dissolving the second mixture to precipitate the insoluble barium sulfate (BaSO₄); separating the precipitated barium sulfate (BaSO₄) by solid-liquid separation; and evaporating the solution from which the barium sulfate (BaSO₄) is separated to obtain lithium hydroxide (LiOH).

The terms used in the present disclosure have been selected as widely used as possible, but in certain cases, the applicant has arbitrarily selected terms, and in such cases, the meaning of the terms should be determined by considering the meaning written or used in the specific description for practicing the disclosure, rather than the mere name of the term.

Hereinafter, the technical configuration of the present disclosure will be described in detail with reference to preferred embodiments illustrated in the accompanying drawings.

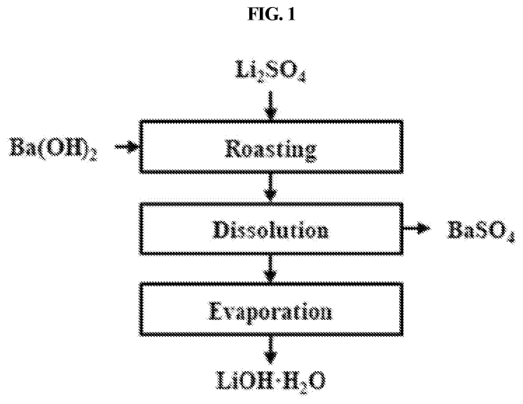

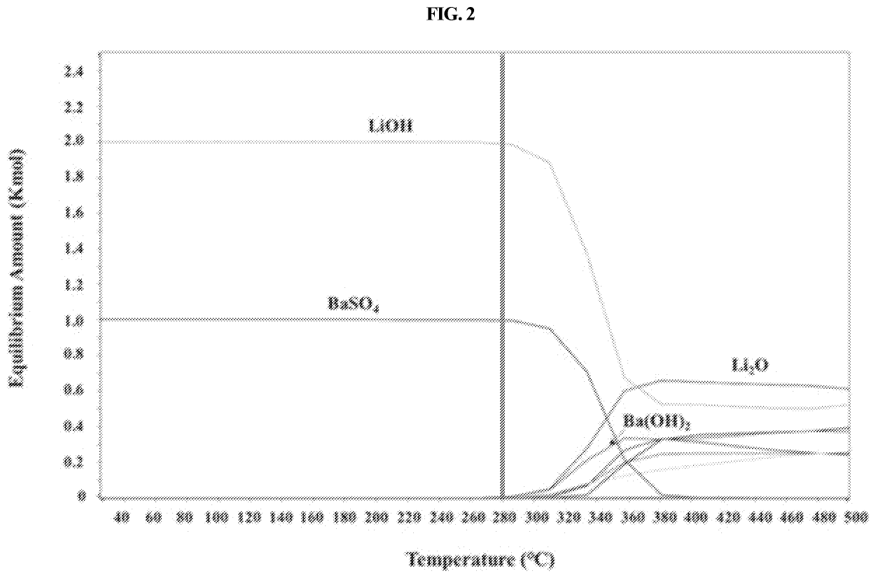

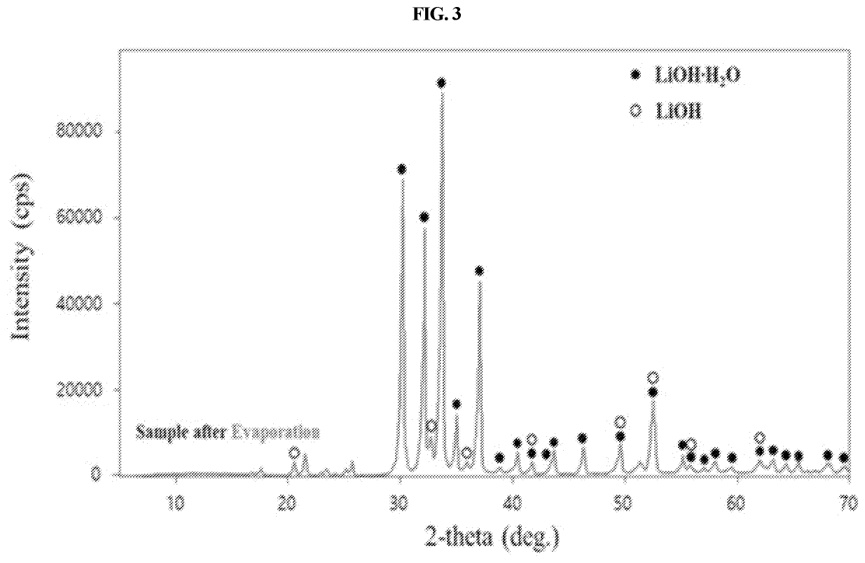

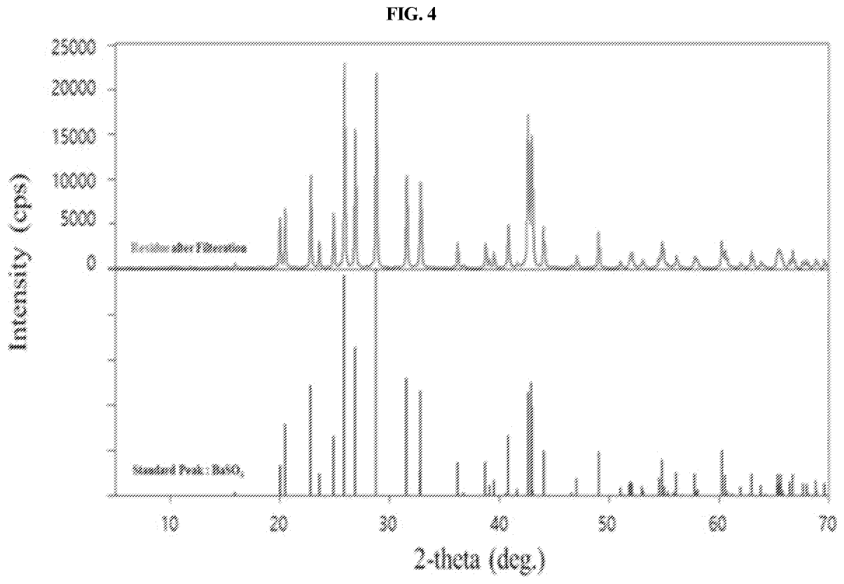

In this regard, first, FIG. 1 is an overall process diagram of a lithium hydroxide preparing method using lithium sulfate and barium hydroxide according to an embodiment of the present disclosure, FIG. 2 is a graph confirming that roasting the first mixture according to an embodiment of the present disclosure converts the first mixture into barium sulfate (BaSO₄) and lithium hydroxide (LiOH), FIG. 3 is an XRD result confirming that lithium hydroxide (LiOH) is prepared by the method according to an embodiment of the present disclosure, and FIG. 4 is an XRD result confirming that the solid-liquid separated precipitate is barium sulfate (BaSO₄) according to an embodiment of the present disclosure.

Referring to FIGS. 1 to 4 above, a method for preparing lithium hydroxide using lithium sulfate and barium hydroxide according to an embodiment of the present disclosure includes mixing lithium sulfate (Li₂SO₄) and barium hydroxide (Ba(OH)₂) in a certain ratio to prepare a first mixture.

In this case, the first mixture is a mixture of lithium sulfate (Li₂SO₄) and barium hydroxide (Ba(OH)₂) as described above, and the method for preparing lithium hydroxide using lithium sulfate and barium hydroxide according to an embodiment of the present disclosure can produce battery-grade, high-purity lithium hydroxide using not only high-purity lithium sulfate but also low-purity lithium sulfate at low cost.

On the other hand, the first mixture is a mixture of lithium sulfate (Li₂SO₄) and barium hydroxide (Ba(OH)₂) as described above. In this case, in an embodiment of the present disclosure, the lithium sulfate (Li₂SO₄) and hydroxide Barium (Ba(OH)₂) is mixed in a molar ratio of 1:1 or 1:1.1.

On the other hand, the method of preparing lithium hydroxide using lithium sulfate and barium hydroxide, according to an embodiment of the present disclosure, includes preparing a second mixture that is converted into insoluble barium sulfate (BaSO₄) and water-soluble lithium hydroxide (LiOH) by roasting the first mixture.

In this case, according to an embodiment of the present disclosure, the roasting of the first mixture is performed in an electric furnace at 200° C. to 280° C. for 2 to 4 hours, and the reason for this numerical limitation for the roasting conditions is that the first mixture is best converted into barium sulfate (BaSO₄) and lithium hydroxide (LiOH) when roasted under such conditions, as shown in FIG. 2.

On the other hand, the method for preparing lithium hydroxide using lithium sulfate and barium hydroxide, according to an embodiment of the present disclosure, includes dissolving the second mixture to precipitate the insoluble barium sulfate (BaSO₄) and separating the precipitated barium sulfate (BaSO₄) by solid-liquid separation.

As described above, barium sulfate (BaSO₄) and lithium hydroxide (LiOH) converted through roasting of the first mixture have characteristics of insolubility and water solubility, respectively, and since the final purpose of the embodiment of the present disclosure is to obtain only the lithium hydroxide (LiOH), it is necessary to separate the precipitated barium sulfate (BaSO₄).

Accordingly, in the embodiment of the present disclosure, the precipitated barium sulfate (BaSO₄) is separated through a solid-liquid separation method to separate the above-mentioned insoluble barium sulfate (BaSO₄).

At this time, the solid-liquid separation method has been described as an example of the separation method of barium sulfate (BaSO₄), but it will not necessarily be limited thereto, and various methods can be used to achieve the same purpose.

Meanwhile, the method for preparing lithium hydroxide using lithium sulfate and barium hydroxide, according to an embodiment of the present disclosure, includes evaporating a solution from which barium sulfate (BaSO₄) is separated to obtain lithium hydroxide (LiOH).

That is, in an embodiment of the present disclosure, insoluble barium sulfate (BaSO₄) is separated, and an aqueous solution containing only lithium hydroxide (LiOH) is concentrated by evaporation to finally obtain high-purity lithium hydroxide.

As a result, the lithium hydroxide preparation method using lithium sulfate and barium hydroxide, according to the embodiments of the present disclosure, enables not only the direct preparation of lithium hydroxide with high purity and low lithium loss rate through the above-described technical configurations but also has excellent eco-friendly effects due to its simple process compared to the related art, which is economical, energy-efficient, and waste-free.

As discussed above, the present disclosure has been shown and described with reference to preferred embodiments but is not limited to such embodiments, and various changes and modifications may be made by one having ordinary skill in the art to which the disclosure belongs without departing from the spirit of the disclosure.

The method for preparing lithium hydroxide using lithium sulfate and barium hydroxide, according to an embodiment of the present disclosure, enables not only direct preparation of lithium hydroxide with high purity and low lithium loss rate using lithium sulfate and barium hydroxide, but also has excellent eco-friendly effects due to its simple process compared to the related art, and is economical, energy efficiency, and no waste generation so that the present disclosure can be used in industry.

1. A method for preparing lithium hydroxide, the method comprising:
preparing a first mixture by mixing lithium sulfate (Li₂SO₄) and barium hydroxide (Ba(OH)₂);
preparing a second mixture that is converted into insoluble barium sulfate (BaSO₄) and water-soluble lithium hydroxide (LiOH) by roasting the first mixture;
dissolving the second mixture to precipitate the insoluble barium sulfate (BaSO₄);
separating the precipitated barium sulfate (BaSO₄) by solid-liquid separation to obtain a solution from which the barium sulfate (BaSO₄) is separated; and
evaporating the solution to obtain lithium hydroxide (LiOH).

2. The method of claim 1, wherein the first mixture comprises the lithium sulfate (Li₂SO₄) and the barium hydroxide (Ba(OH)₂) in a molar ratio of 1:1.

3. The method of claim 2, wherein preparing the second mixture that is converted into insoluble barium sulfate (BaSO4) and water-soluble lithium hydroxide (LiOH) by roasting the first mixture is performed in an electric furnace at 200° C. to 280° C. for 2 to 4 hours.
